(19) United States
(12) Patent Application Publication
(10) Pub. No.: US 2020/0229650 A1
(43) Pub. Date: Jul. 23, 2020

(54) METHOD TO COOK FOWL AND OTHER UNITARY FOODS

(71) Applicant: Alan BACKUS, Los Angeles, CA (US)

(72) Inventor: Alan BACKUS, Los Angeles, CA (US)

(21) Appl. No.: 16/839,443

(22) Filed: Apr. 3, 2020

Related U.S. Application Data
(63) Continuation-in-part of application No. 15/920,947, filed on Mar. 14, 2018, now abandoned.
Application No. 15/920,947 is a continuation-in-part of application No. 15/899,145, filed on Feb. 19, 2018.
Application No. 15/899,145 is a continuation of application No. 14/253,253, filed on Apr. 15, 2014, now abandoned.
Application No. 14/253,253 is a continuation-in-part of application No. 13/072,391, filed on Mar. 25, 2011, now abandoned.
Application No. 13/072,391 is a continuation-in-part of application No. 12/904,803, filed on Oct. 14, 2010, now abandoned.
Application No. 12/904,803 is a continuation-in-part of application No. 12/856,230, filed on Aug. 13, 2010, now Pat. No. 8,309,151.
Application No. 12/856,230 is a continuation-in-part of application No. 12/775,725, filed on May 7, 2010, now Pat. No. 8,186,265.
Application No. 12/775,725 is a continuation-in-part of application No. 12/251,019, filed on Oct. 14, 2008, now Pat. No. 8,850,965.
Application No. 12/251,019 is a continuation-in-part of application No. 11/345,187, filed on Feb. 1, 2006, now abandoned.
Application No. 12/251,019 is a continuation-in-part of application No. 11/425,317, filed on Jun. 20, 2006, now Pat. No. 8,707,857.
Application No. 11/425,317 is a continuation-in-part of application No. 11/345,187, filed on Feb. 1, 2006, now abandoned.
Application No. 12/251,019 is a continuation-in-part of application No. 11/539,655, filed on Oct. 9, 2006, now abandoned.
Application No. 11/539,655 is a continuation-in-part of application No. PCT/US2006/030946, filed on Aug. 8, 2006.
Application No. PCT/US2006/030946 is a continuation of application No. 11/425,317, filed on Jun. 20, 2006, now Pat. No. 8,707,857.
Application No. 11/425,317 is a continuation-in-part of application No. 11/345,187, filed on Feb. 1, 2006, now abandoned.
(60) Provisional application No. 60/706,859, filed on Aug. 8, 2005.
(60) Provisional application No. 60/706,859, filed on Aug. 8, 2005.
(60) Provisional application No. 60/706,859, filed on Aug. 8, 2005.

(51) Int. Cl. A47J 43/18; A47J 37/12; A23L 13/50; A23L 5/10

(52) U.S. Cl. CPC A47J 43/18; A47J 37/1219; A23L 5/11; A23L 13/57; A47J 37/1209

(57) ABSTRACT

A method for cooking fowl and/or other unitary food articles utilizing multiple immersions into hot cooking fluid includes cooking central portions of fowl, or other unitary food articles, for longer durations than one or both end portions of the fowl or unitary food articles by cooking central portions twice and cooking one or both end portions only once.

### CROSS-REFERENCE TO RELATED APPLICATIONS

This application is a Continuation-in-Part of U.S. patent application Ser. No. 15/920,947 filed on Mar.14, 2018. This application is also a Continuation-in-Part of U.S. patent application No. 15/899,145, filed Feb. 19, 2018, which is a Continuation of U.S. patent application No. 14/253,253, filed Apr. 15, 2014, which is a Continuation-in-Part of U.S. patent application No. 13/072,391, filed Mar. 25, 2011, which is a Continuation-in-Part of U.S. patent application No. 12/904,803, filed Oct. 14, 2010, which is a Continuation-in-Part of U.S. patent application No. 12/856,230, filed Aug. 13, 2010, which is a Continuation-in-Part of U.S. patent application No. 12/775,725, filed May 7, 2010, which is a Continuation-in-Part of U.S. Ser. No. 12/251,019, filed Oct. 14, 2008, which is a Continuation-in-Part of 1) U.S. patent application Ser. No. 11/345,187, filed Feb. 1, 2006, which claims the benefit of U.S. Provisional Application No. 60/706,859, filed Aug. 8, 2005; 2) U.S. patent application Ser. No. 11/425,317, filed Jun. 20, 2006, which is a Continuation-in-Part of U.S. patent application Ser. No. 11/345,187, filed on Feb. 1, 2006, which claims the benefit of U.S. Provisional Application No. 60/706,859, filed Aug. 8, 2005; and 3) U.S. patent application Ser. No. 11/539,655, filed Oct. 9, 2006, which is a Continuation-in-Part of PCT Patent Application No. PCT/US2006/30946, filed Aug. 8, 2006, which is a Continuation of U.S. patent application Ser. No. 11/425,317, filed Jun. 20, 2006, which is a Continuation-in-Part of U.S. patent application Ser. No. 11/345,187, filed Feb. 1, 2006, which claims the benefit of U.S. Provisional Application No. 60/706,859, filed Aug. 8, 2005, all of which are incorporated herein by reference.

### TECHNICAL FIELD

The subject application is directed toward methods to cook fowl and other unitary articles of food.

### BACKGROUND

Today there are a myriad of methods for cooking fowl, including, but not limited to: baking, broiling, microwaving, and deep frying. What these methods share in common is that they uniformly heat all portions of the fowl being cooked. This means that in order to correctly cook the meaty central or middle portions of the fowl, the end portions are generally overcooked, both because the end portions are less meaty, and because the end portions are exposed on all sides to a cooking temperature environment. This contrasts with the central or middle portions of a fowl being cooked, which are only surrounded on their outer perimeter surfaces by a cooking temperature environment.

In real-world terms this means that the ends of the legs and tail are generally tough and overcooked, when the central portion of the fowl is cooked properly.

What would be useful is a cooking method for cooking fowl and other unitary food articles which properly cooked the central portions without overcooking the end portions.

### SUMMARY

Embodiments of the subject application include cooking central portions of fowl, or other unitary food articles, for longer durations than one or both end portions of the fowl or unitary food articles by, in essence, cooking central portions twice and cooking one or both end portions only once.

### SUMMARY OF THE DRAWINGS

Various embodiments will become better understood with regard to the following description, appended claims and accompanying drawings wherein:

FIG. 1 is a perspective of an example embodiment of a fowl cooking system 100.

FIG. 2 is a side view of fowl 102, including hatching 104 (running from lower left to upper right) indicating portions of fowl 102 immersed in hot cooking fluid during a first cooking cycle, and also including hatching 106 (running from upper left to lower right), indicating portions of fowl 102 immersed in hot cooking fluid during a second cooking cycle, and further including double crosshatched portion 108 indicating portions of fowl 102 which are the immersed in hot cooking fluid during both a first cooking cycle and a second cooking cycle.

FIG. 3 is a side view of embodiment 100, including showing, in dotted lines, cooking vessel 110 and fowl 102, which are inside of embodiment 100; and showing hot cooking fluid 112 within cooking vessel 110 with hatching.

FIG. 4 is a side view of embodiment 100, including showing, in dotted lines, cooking vessel 110 and fowl 102, which are inside of embodiment 100, and showing hot cooking fluid 114 within the cooking vessel 110 with hatching.

FIG. 5 is an exploded perspective of embodiment 100 showing: lid 116, cooking vessel extender ring 118, food support 120, fowl 102, control box/heat coil 122, and outer enclosure 124.

### DETAILED DESCRIPTION

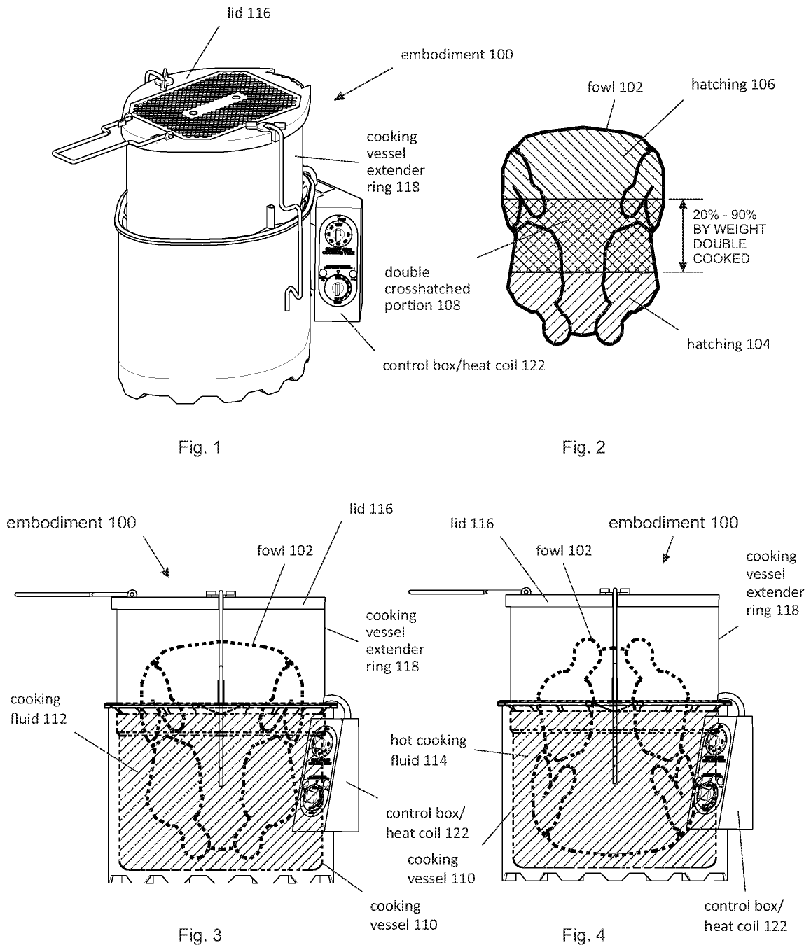

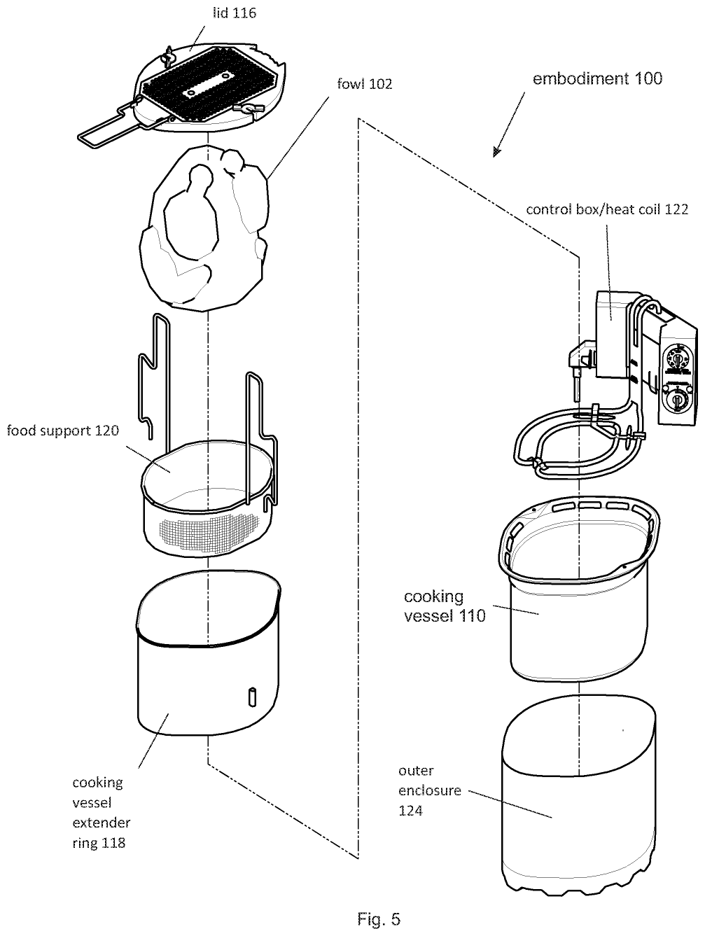

FIG. 1 shows a perspective view of a deep fryer practicing a method for cooking a fowl or other unitary food articles. Such a method may comprise the steps of:
immersing legs down, 60% to 95% by weight of fowl 102 into hot cooking fluid 112, and leaving fowl 102 in the hot fluid long enough for cooking to occur (FIG. 3);
repositioning fowl 102 to be legs up;
immersing, legs up, 60% to 95% by weight of fowl 102 into hot cooking fluid 114, and leaving fowl 102 in cooking fluid 114 long enough for cooking to occur such that all of fowl 102 is cooked at least once, and 20% to 90% by weight of fowl 102 is cooked at least twice (FIGS. 2 and 4); and
removing fowl 102 from hot cooking fluid 114 and serving it to eat.

The above method cooks central portions of fowl 102 twice while cooking the peripheral longitudinal ends of fowl 102 only once (FIG. 2). This may help prevent overcooking the opposite ends of fowl 102.

Certain unitary foods may have one side that requires more cooking than the other. By way of example, a turkey is considered fully cooked when a temperature within an innermost thigh achieves about 165° Fahrenheit or 74° Centigrade. In another example embodiment, the entire unitary food is cooked by total immersion in a first cooking process wherein a portion is considered fully cooked with a second portion requiring further cooking. A second cooking process exposes a portion of the food to cooking fluid by partial immersion. With such a procedure, the food may be cooked more uniformly, wherein no portion of the food is undercooked nor overcooked.

Other unitary food articles, such as, by way of non-limiting and non-exhausted examples, ham, leg of lamb, roast, or any other suitable comestibles, may be substituted for fowl 102 above.

Hot cooking fluid 114, as non-limiting and non-exhausted examples, may comprise frying oil, water, soups, stews, sauces or any other suitable fluid.

Any suitable apparatus may be used in place of embodiment 100. As non-limiting and non-exhausted examples, range top pots and pans, deep fryers, roasters, slow cookers, pressure cookers, multi-cookers, pots, pans and vessels placed in ovens, or any other suitable apparatus.

In each case, the food article is partially immersed in hot cooking fluid and left there for long enough for cooking to occur. The food article is then repositioned so that portions of the food article not cooked in the first cooking cycle are cooked in a second cooking cycle, and 20% to 90% of the food article is cooked twice, once during the first cooking cycle, and a second time during the second cooking cycle.

In the above examples, fowl 102 is immersed to approximately the same depth in both the first and the second cooking cycles. However, the depth of immersion into the cooking fluid may be greater or less in the first cooking cycle, than the second cooking cycle.

As a non-limiting and non-exhaustive example, 70% of fowl 102 by weight is suitably immersed during the first cooking cycle, and only 50% of fowl 102 by weight is suitably be immersed during the second cooking cycle. This would mean that 20% of the meaty center portion of fowl 102 was cooked twice, but the tail end of fowl 102 comprising 30% by weight of fowl 102 and including the less meaty legs and tail of fowl 102 are cooked only once, whereas the breast end of fowl 102, comprising only 10% by weight of fowl 102, and which has more meat than the legs and tail end is also cooked only once.

As yet another non-limiting and non-exhausted example, 100% of fowl 102 by weight is suitably immersed during the first cooking cycle, and 80% of fowl 102 by weight of fowl 102, excluding the less meaty legs and tail, is suitably immersed during the second cooking cycle. Such asymmetric immersions are suitably accomplished by either adding or removing cooking fluid between the first and the second cooking cycles, and/or by altering food support to change the depth to which fowl 102 is allowed to lower into the cooking fluid.

As yet another non-limiting and non-exhausted example, the directly above example suitably have its first and second cooking cycles reversed so that 80% of the breast end down of the fowl is cooked first, and the fowl is then repositioned so that its totality is immersed thereafter. In each instance, 20% or more of the fowl or unitary food article is immersed in hot cooking fluid twice, with a remaining portions being cooked only once. Cooking times for the first and second cooking cycles may be the same or may be different.

What is claimed is:

1. A method for cooking a fowl utilizing hot frying oil, comprising:
in a first cooking cycle, partially immersing a fowl, legs down, into hot frying oil such that 60% to 95% of the fowl by weight is immersed, and leaving the partially immersed fowl in the hot frying oil long enough for cooking to occur;
in a second cooking cycle, repositioning the fowl to be breast down, and partially immersing the fowl in hot frying oil such that 60% to 95% of the fowl by weight is immersed long enough for cooking to occur such that all portions of the fowl not immersed in hot frying oil during the first cooking cycle are the immersed in the second cooking cycle, and such that at 20% to 90% by weight of the fowl is immersed twice in the hot frying oil, once during the first cooking cycle, and once more during the second cooking cycle; and
removing the fowl from the hot frying oil.

2. The method of claim 1 wherein the hot frying oil is contained in a vessel configured to rest on a home kitchen countertop.

3. The method of claim 2, further including heating frying oil within the vessel to frying temperatures with an electrically energized heater.

4. A method for cooking a unitary food article utilizing hot frying oil, comprising:
in a first cooking cycle, partially immersing a unified food article having a first end and an opposing second end, with first end of the unified article down, into hot frying oil such that 60% to 95% of the fowl by weight is immersed, and leaving the first end in the hot frying oil long enough for cooking to occur;
in a second cooking cycle, repositioning the unitary food article with a second end down, and partially immersing the unitary food article in hot frying oil such that 60% to 95% of the fowl by weight is immersed long enough for cooking to occur, and such that all portions of the unitary food article not immersed in hot frying oil during the first cooking cycle, are the immersed in the second cooking cycle, and such that at least 20% to 90% by weight of the unitary food article is immersed twice in the hot frying oil, once during the first cooking cycle, and once more during the second cooking cycle; and
removing the unitary food article from the hot frying oil.

5. The method of claim 4 wherein the hot frying oil is contained in a vessel configured to rest on a home kitchen countertop.

6. The method of claim 5, further including heating frying oil within the vessel to frying temperatures with an electrically energized heater.

7. A method for cooking a unitary food article utilizing hot cooking fluid, comprising:
in a first cooking cycle, immersing a unitary food article having a first end and an opposing second end with the first end placed into hot cooking fluid such that 60% to 95% of the unitary food by weight is immersed, and leaving the first end in the hot cooking fluid long enough for cooking to occur;
in a second cooking cycle, repositioning the unitary food article with a second end down, and immersing the unitary food article in hot cooking fluid such that 60% to 95% of the unitary food by weight is immersed long enough for cooking to occur, and such that 20% to 90% by weight of the unitary food article is immersed twice in the hot cooking fluid, once during the first cooking cycle, and once more during the second cooking cycle; and
removing the unitary food article from the hot cooking fluid.

8. The method of claim 7, further including the hot cooking fluid being contained in a vessel configured to rest on a home kitchen countertop.

9. The method of claim 8, further including heating cooking fluid within the vessel to cooking temperatures with an electrically energized heater.

10. A method for cooking a unitary food article utilizing hot cooking fluid, comprising:
in a first cooking cycle, fully immersing a unitary food article having a first end and an opposing second end with the first end placed into hot cooking fluid long enough for partial cooking to occur;
in a second cooking cycle, repositioning the unitary food article with a second end down, and immersing the unitary food article in hot cooking fluid such that 60% to 95% of the unitary food by weight is immersed long enough for complete cooking , and such that 20% to 90% by weight of the unitary food article is immersed twice in the hot cooking fluid, once during the first cooking cycle, and once more during the second cooking cycle; and
removing the unitary food article from the hot cooking fluid.

11. The method of claim 7, further wherein the unitary food article is a fowl.

12. The method of claim 11, further wherein the first end is comprised of legs of the fowl.
